(19) United States
(12) Patent Application Publication
(10) Pub. No.: US 2005/0188064 A1
(43) Pub. Date: Aug. 25, 2005

(54) Using a configuration mode for partition management in server platforms

(76) Inventor: Ioannis Schoinas, Portland, OR (US)

Correspondence Address: TROP PRUNER & HU, PC, 8554 KATY FREEWAY, SUITE 100, HOUSTON, TX, 77024, US

(21) Appl. No.: 10/787,869

(22) Filed: Feb. 24, 2004

(51) Int. Cl. G06F 15/177; G06F 15/173

(52) U.S. Cl. 709/221; 709/223

(57) ABSTRACT

A configuration agent may control domain partition management in a server platform. A configuration agent may allow out-of-band system management agents to directly access configuration registers which control domain partitions. Accesses by in-band agents may only be allowed, in some embodiments, during a configuration mode, such as a system management mode.

### BACKGROUND

This invention relates generally to server platforms.

A server platform may include one or more processors. A server platform may control access to a network and/or respond to commands from clients on a network.

A server may, for example, be made up of a large number of processors serviced by a service processor. Those processors may be interconnected by crossbar switches that allow communication between the processors and available memory. Servers of this type may divide the platform into a variety of domain partitions. There are a variety of reasons for partitioning, but, in general, partitioning improves system manageability.

Each partition may be configured using configuration registers. Those registers may be accessed by authorized agents to set the configuration data. Domain partitioning may include multiple physically separate blocks within one silicon die. These different blocks may communicate by a central internal crossbar switch.

As the number of partitions increase, the management of those domains and their configuration increase in complexity. Thus, there is a need for better ways to maintain domain partitions and their configurations in server platforms.

### BRIEF DESCRIPTION OF THE DRAWINGS

FIG. 1 is a schematic depiction of one embodiment of the present invention;

FIG. 2 is a flow chart for software for implementing partition management in accordance with one embodiment of the present invention;

FIG. 3 is a flow chart for implementing a configuration mode access in accordance with one embodiment of the present invention; and

FIG. 4 is a flow chart for software for securing configuration registers.

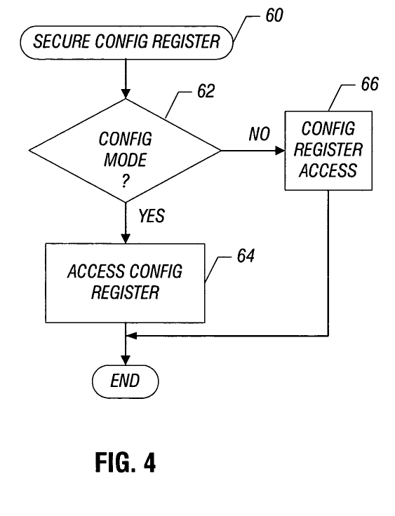

### DETAILED DESCRIPTION

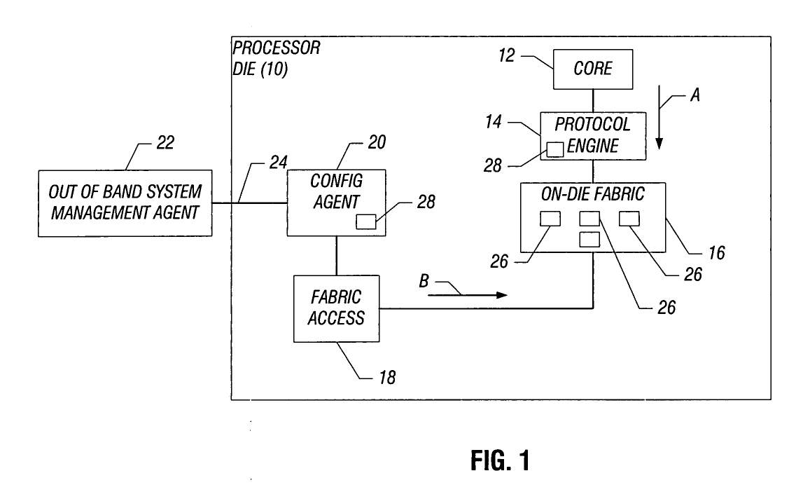

Referring to FIG. 1, a processor die 10 that communicates over a bus 24 with an out-of-band system management agent 22. In one embodiment, the out-of-band system management agent 22 may be a service processor and the processor die 10 may be a die for a server platform served by the service processor 22. In some cases, the bus 24 may be a System Management Bus (SMBus) or a Joint Test Action Group (JTAG) bus, to mention two examples.

A configuration agent 20 may interface to the bus 24 onboard of the processor die 10. The configuration agent 20 may include configuration status registers 28 in one embodiment of the present invention. In order to program a configuration register 26, a configuration packet may be sent to the appropriate addressable configuration agent 20. The agent 20 performs the configuration operation. In one embodiment, the only function of the agent 20 is configuration.

The agent 20 may communicate with a fabric access 18, which controls access to on-die fabric 16 in one embodiment of the present invention. Out-of-band configuration accesses, indicated by the arrow B, may always proceed to the fabric target in one embodiment.

Conversely, the core 12 may communicate through a protocol engine 14. In some cases, a large number of cores 12 and a large number of protocol engines 14 may be provided. The protocol engines 14 may have their own configuration registers 26 in one embodiment. Core configuration accesses, indicated by the arrow A, can proceed only when the core 12 is running protected firmware in one embodiment.

The on-die fabric 16 may include a number of configuration registers 26 in one embodiment of the present invention. Configuration status registers 28 may store a status bit that indicates whether a particular domain partition is accessible during a configuration mode. A configuration mode is a mode in which changes to configuration settings stored in configuration registers 26 are possible. In normal mode, no such accesses are possible.

In one embodiment of the present invention, the configuration mode may correspond to the system management mode. The system management mode allows system developers to provide low level functions, such as power management or security, in a manner that is transparent to operating systems and application programs. The system management mode allows operating system and application software operation to be interrupted to perform certain low level functions. After such low level functions are performed, operating system or application software operation may be resumed from the point of interruption. While an example is given in which the configuration mode corresponds to the system management mode, other embodiments are contemplated and the present invention is not limited to any specific form of configuration mode.

In accordance with some embodiments of the present invention, changes to the configuration registers 26 can only be implemented in the configuration mode in the case of accesses that are so-called in-band accesses. An in-band access is one which originates from within the processor die 10 itself.

An out-of-band access is one which is forwarded from an out-of-band system management agent 22. Since the out-of-band system management agent 22, such as a service processor, is effectively an agent for controlling the operation of the processor 10, its accesses are considered to be trusted accesses. Conversely, accesses from within the die 10 may be generated by application programs or operating system software that may be manipulated by untrusted individuals. It may be undesirable to allow unauthorized individuals to gain access to configuration registers 28 that can be programmed to different values to create undesired or unauthorized system usage modes. Examples of configuration registers 26 for configuring domain partitions include configuration registers on processors, chipset address decoders, and routing tables.

The processor die 10 may need to indicate to other entities, including processor protocol engines 28, system logic, service processors, and out-of-band system management agents 22, when it is operating in a configuration mode. To this end, configuration mode status registers 28 may be provided.

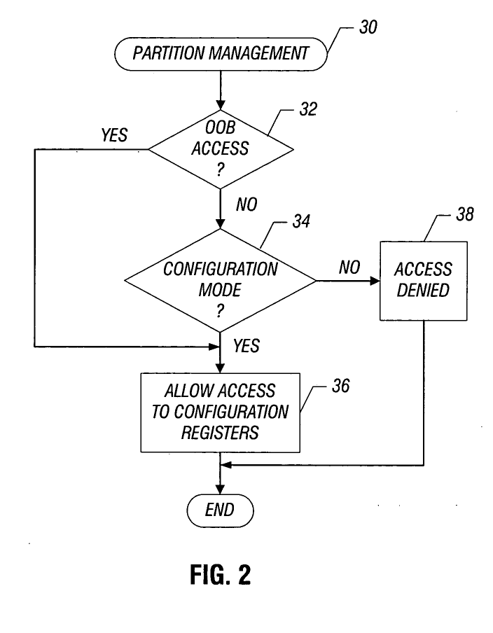

Referring to FIG. 2, partition management firmware 30, in one embodiment of the present invention, may be firmware stored on the die 10. In other embodiments, the firmware 30 may be fetched from sources external to the die 10. The firmware 30 may allow management of domain partitions and configuration registers 26 that control domain partitioning. An out-of-band access is detected as determined in diamond 32. An out-of-band system management agent 22 may be granted to access configuration registers 26, as indicated in block 36, since the management agent 22 is a trusted source.

Alternatively, as determined in diamond 34, if the access is in-band and the platform is in a configuration mode, access to configuration registers 26 may be allowed, as indicated in block 36. In all other cases, access may be denied as indicated in block 38.

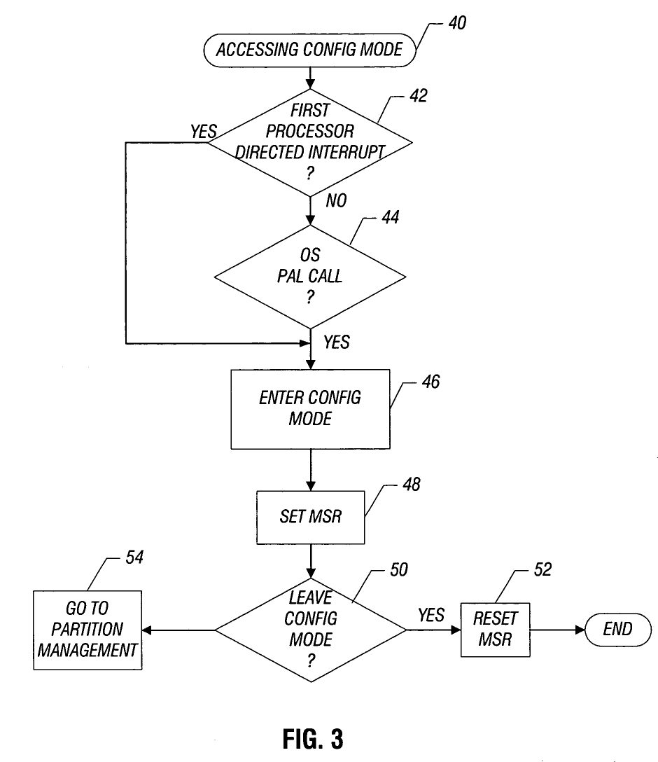

In order to access the configuration mode, the firmware 40, illustrated in FIG. 3, may be part of a system firmware layer. The firmware 40 determines when a transition to the configuration mode has occurred because another entity directed an interrupt to the processor die 10, as indicated in diamond 42. The another entity that directs the interrupt may be a chipset component or a service processor, to give two examples. A directed interrupt may be a platform management interrupt (PMI) or system management interrupt (SMI), as two examples. The power management interrupt may have its own calling conventions and core resources. Following receipt of a directed interrupt, a processor thread servicing the interrupt may implicitly enter the configuration mode.

In order to secure the directed interrupt entry point, an operating system may not be able to modify the associated configuration register 26. This operating system deprivileged state can be achieved by making the register 26 accessible only when the processor is in the configuration mode. For initialization purposes, the processor may start executing firmware in the configuration mode on power-on, reset, and initialization. Subsequently, the entry points may be secured by making the registers that hold the reset and initialization entry points inaccessible to the operating system.

Exiting the configuration mode may be done by directly exporting a model specific register (MSR). A bit in configuration status register 28 may be cleared before returning to operating system control. Again, the model specific register may be only accessible when the platform is in configuration mode.

In addition, an operating system may be able to directly invoke the system management functions through a processor abstraction layer (PAL) or a system abstraction layer (SAL) call. When a PAL or SAL call is issued or an interrupt is received from an out-of-band request, a platform may enter the configuration mode and start executing code from a predefined location.

When an operating system PAL call is detected in diamond 44, the configuration mode may be entered as indicated in block 46. Thereafter, a model specific register may be set, as indicated in block 48, to indicate that the processor is in the configuration mode. Upon leaving the configuration mode, as determined in diamond 50, the model specific register bit may be reset as indicated in block 52. If it is not yet time to depart the configuration mode, partition management functions may be implemented as indicated in block 54.

Protected configuration registers may only be accessible by out-of-band agents and by the processor when the processor runs in the configuration mode. The protected register set may include, for example, the registers that can affect more than one partition, as well as any configuration mode registers 26, since unauthorized access can compromise security. However, chipset or processor registers normally visible to the operating system or device drivers may belong to an unprotected set. In one embodiment, the unprotected set may be replicated if a single component supports more than one partition.

In order to access protected registers 26 in another component, a processor protocol engine 14 may be aware of the configuration mode status. This information may be used to access address map registers. Accesses that do not have the configuration bit set may not match the address registers that do have the configuration bit set in one embodiment. On the other hand, accesses that do have the configuration bit set match all address registers.

A status bit can also be included in a protocol header in one embodiment. When remote components receive transactions directed toward a protected register set, the remote components may check to ensure that the transaction has a bit set for allowing the access to proceed.

Normally protected registers may be placed in a portion of the address space separate from unprotected registers. In this way, firmware can put an entry in the address maps that allows access to protected registers 26 only when the processor is running in the configuration mode. One reason to include the bits in both the address map and the protocol heading is to allow mixing of the protected registers with the unprotected registers in the physical address space, relying on the packet header to protect the registers. This approach may be useful to decrease pressure on address map registers. Relying on the packet header allows both the protected and unprotected registers to share an address map entry.

The location of the configuration mode code and data may be in a portion of physical memory not accessible by the main operating system. In other words, the physical memory where the configuration code and data are stored may be inaccessible outside the configuration mode.

In the processor cache domain, protection may be enforced by the processor core itself. For example, a check in the processor translation look aside buffer (TLB) may be performed when new entries are loaded on a translation look aside buffer miss. In some cases, the configuration mode may simply bypass the cache. In other cases, the cache may be flushed before exiting the configuration mode.

In some embodiments of the present invention, service processors need not be used for configuration of system resources such as platform configuration registers that cannot be accessed by the operating system. In some embodiments, the system management architecture may be standardized throughout the scalability range of server platforms. In some embodiments, operating system code need not be extensively modified to support domain partitioning.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
managing domain partitions in a server platform using a configuration mode.

2. The method of claim 1 including using a configuration mode that corresponds to a system management mode.

3. The method of claim 1 including allowing out-of-band accesses to access configuration mode registers.

4. The method of claim 3 including allowing out-of-band accesses to access configuration registers regardless of whether the configuration mode is active.

5. The method of claim 1 including allowing in-band accesses to configuration registers only when the configuration mode is active.

6. The method of claim 1 including handling out-of-band configuration register accesses using a dedicated configuration agent.

7. The method of claim 1 including storing a configuration bit to indicate whether the configuration mode is active or not.

8. The method of claim 1 including preventing application programs and an operating system from accessing a configuration register when the configuration mode is not active.

9. The method of claim 1 including implementing the configuration mode in response to a processor abstraction layer call.

10. The method of claim 1 including placing a configuration register in a portion of address space separate from other registers.

11. An article comprising a medium storing instructions that, if executed, enable a server platform to:
manage domain partitions using a configuration mode.

12. The article of claim 11 further storing instructions that, if executed, enable the platform to use a configuration mode that corresponds to a system management mode.

13. The article of claim 11 further storing instructions that, if executed, enable the platform to allow out-of-band accesses to access configuration mode registers.

14. The article of claim 13 further storing instructions that, if executed, enable the platform to allow out-of-band accesses to access configuration registers regardless of whether the configuration mode is active.

15. The article of claim 11 further storing instructions that, if executed, enable the platform to allow in-band accesses to configuration registers only when the configuration mode is active.

16. The article of claim 11 further storing instructions that, if executed, enable the platform to handle out-of-band configuration register accesses using a dedicated configuration agent.

17. The article of claim 11 further storing instructions that, if executed, enable the platform to store a configuration bit to indicate whether the configuration mode is active or not.

18. The article of claim 11 further storing instructions that, if executed, enable the platform to prevent application programs and an operating system from accessing a configuration register when the configuration mode is not active.

19. The article of claim 11 further storing instructions that, if executed, enable the platform to implement the configuration mode in response to a processor abstraction layer call.

20. The article of claim 11 further storing instructions that, if executed, enable the platform to place a configuration register in a portion of address space separate from other registers.

21. A server platform comprising:
a processor die including a configuration agent to manage a domain partition using a configuration mode; and
an out-of-band system management agent.

22. The platform of claim 21 wherein said out-of-band system management agent is a service processor.

23. The platform of claim 21 wherein said configuration mode corresponds to a system management mode.

24. The platform of claim 21, said configuration agent to allow out-of-band accesses to access configuration mode registers.

25. The platform of claim 24, said configuration agent to allow out-of-band accesses to access configuration registers regardless of whether the configuration mode is active.

26. The platform of claim 21, said configuration agent only to allow in-band accesses to configuration registers when the configuration mode is active.

27. The platform of claim 21 including a register storing a configuration bit to indicate whether the configuration mode is active.

28. The platform of claim 21, said configuration agent to prevent application programs and an operating system from accessing a configuration register when the configuration mode is not active.
